(19) United States
(12) Patent Application Publication
(10) Pub. No.: US 2006/0028423 A1
(43) Pub. Date: Feb. 9, 2006

(54) Structures and methods of temperature compensation for LCD

(75) Inventors: Chih-Che Hsu, Xindian City (TW); Ming-Chi Ku, Judong Township (TW)

Correspondence Address: THOMAS, KAYDEN, HORSTEMEYER & RISLEY, L.L.P., Suite 1750, 100 Galleria Parkway, NW, Atlanta, GA, 30339-5948, US

(73) Assignee: AU Optronics Corp.

(21) Appl. No.: 11/085,400

(22) Filed: Mar. 21, 2005

(30) Foreign Application Priority Data
Aug. 3, 2004 (TW) 93123199

(51) Int. Cl. G09G 3/36

(52) U.S. Cl. 345/101

(57) ABSTRACT

Structures of temperature compensation for LCDs. An exemplary structure comprises at least one heat conductor, at least one heat sensor and a computing unit. The heat conductors are arranged on a glass substrate of an LCD panel. The heat sensors are thermally coupled to the heat conductors and generate at least one output signal, according to the heat from the heat conductors, to the computing unit. Accordingly, the computing unit provides a correction value to correct Gamma voltage or V_{com}. Methods of temperature compensation for LCDs also are provided.

### BACKGROUND

The invention relates to liquid crystal display (LCD) panels and, in particular, to a structure of temperature compensation for LCDs.

The temperature of liquid crystal displays (LCDs) increases mainly due to heat generated by a backlight module. Accordingly, transmission of liquid crystal and Vcom characteristic is affected. Thus, to enhance performance of an LCD, a temperature compensation mechanism is required to correct the transmission and Vcom characteristic deviation resulting from increased temperature.

FIG. 1 shows a conventional structure of temperature compensation for an LCD. The structure includes a heat sensor 130 on a gate board 120 next to an LCD panel 110. The heat sensor 130 can be a thermistor. Since the gate board is disposed next to the LCD panel 110 and the backlight module 140, heat distribution of the LCD 110 cannot be directly detected by the heat sensor 130 on the gate board 120. Meanwhile, the heat sensor 130 is influenced by the heat generated by the backlight module. Thus, it is difficult to provide a temperature compensation mechanism for correcting the transmission and Vcom characteristic deviation resulted from increased temperature.

### SUMMARY

Embodiments of the invention utilize heat conductors on a liquid crystal display to extract heat distribution thereof such that correction value of Gamma voltage and common voltage can be adjusted. Thus, a normal display quality can be maintained for a long time.

An embodiment of a structure of temperature compensation for LCD comprises at least a heat conductor, at least a heat sensor and a computing unit. The heat conductors are disposed on a glass substrate of a liquid crystal display. The heat sensors are coupled to the heat conductors. At least one output signal is transmitted to the computing unit according to the heat detected by the heat sensors. The computing unit generates a correction value to correct Gamma voltage and common voltage according to the output signals.

An embodiment of a method of temperature compensation for LCD comprises sensing temperatures in a plurality of regions on an LCD panel; generating a plurality of signals in accordance with the temperature sensed in the plurality of regions; generating a correction value of the one or more voltages for the LCD in accordance with the plurality of signals; and adjusting the one or more voltages.

### DESCRIPTION OF THE DRAWINGS

FIG. 1 shows a conventional structure of temperature compensation for an LCD.

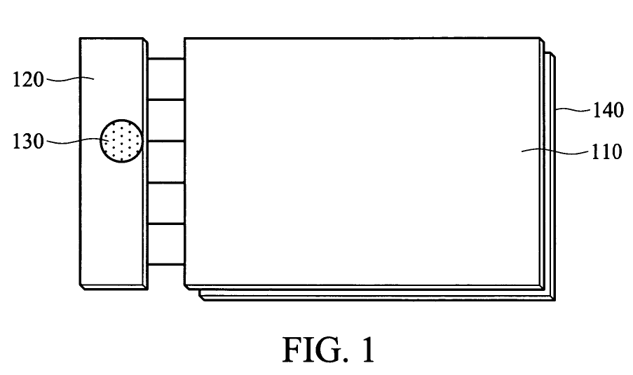

FIG. 2 shows an embodiment of a structure of temperature compensation for LCDs.

FIG. 3 illustrates a method of temperature compensation for LCDs.

### DETAILED DESCRIPTION

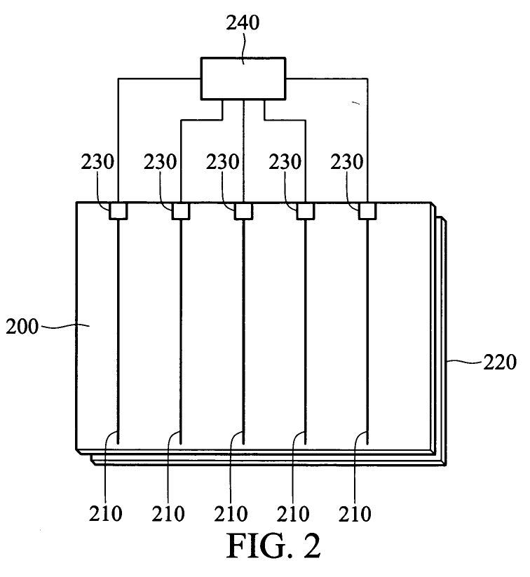

FIG. 2 shows an embodiment of a structure of temperature compensation for LCDs. As shown in FIG. 2, heat conductors 210 are formed on a surface of an LCD panel 200. Generally, a backlight module 220 generates heat. The LCD panel 200 absorbs the heat and a surface temperature thereof increases with operating duration. The heat conductors 210 are distributed in different regions on the LCD panel 200 for conducting the heat accumulated in the different regions thereof. The heat conductors 210 can be gold, silver, copper, aluminum or other heat conductive materials. The heat conductors can also be heat pipes.

As shown in FIG. 2, the heat sensors 230 are coupled to the heat conductors 210. More specifically, the heat sensors 230 can be thermistors. The coupling between the heat sensor 210 and the heat conductors 210 can be accomplished by direct contact, bonding or encapsulation with heat conductive glue. The heat sensors 230 generate at least an output signal according to the received heat. The output signals can be transmitted to a computing unit via circuitry in tape automated bonding (TAB), chip on flex/film (COF), or flexible printed circuit board (FPC) The computing unit 240 is disposed, for example, on a printed circuit board (PCB). The computing unit 240, however, is not necessarily disposed on a printed circuit board (PCB). The computing unit 240 can be implemented with simple linear circuits or alternatively digital circuits in a timing controller (TCON). The computing unit 240 introduces the output signals from the heat sensors 230 into a formula, such as an averaging methodology, such that a correction value is obtained. Thus, the voltages related to display performance are corrected. The voltages related to display performance are typically Gamma voltage (the curve of transmission versus voltage) or common voltage (Vcom).

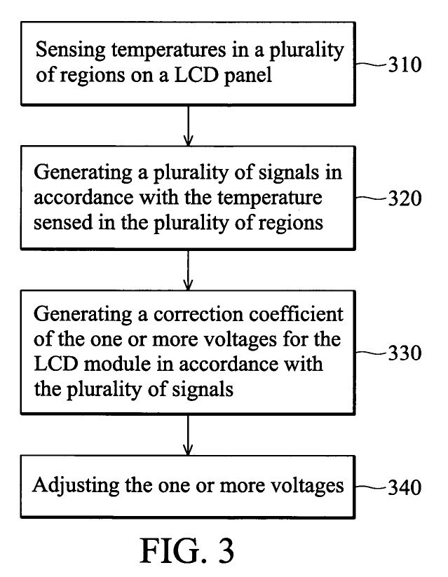

FIG. 3 illustrates a method of temperature compensation for an LCD. The method comprises sensing temperatures in a plurality of regions on an LCD panel (step 310); generating a plurality of signals in accordance with the temperature sensed in the plurality of regions (step 320); generating a correction value of the one or more voltages for the LCD panel in accordance with the plurality of signals (step 330); and adjusting the one or more voltages (step 340). The voltages related to display performance are typically Gamma voltage(the curve of transmission versus voltage) or common voltage (Vcom). The computing unit 240 can be implemented with a simple linear circuitry. Alternatively, the computing unit 240 can be digitally implemented in a timing controller (TCON) and perform voltage correction through a D/A converter (DAC) and an operational amplifier (OP Amp).

Some embodiments of the invention utilize heat conductors on a liquid crystal display to obtain heat distribution thereof. Thus, accuracy of a correction value of Gamma voltage or common voltage can be maintained such that a normal display quality can be maintained for a long time.

While the invention has been described by way of example and in terms of preferred embodiment, it is to be understood that the invention is not limited thereto. Rather, it is intended to cover various modifications and (as would be apparent to those skilled in the art). Therefore, the scope of the appended claims should be accorded the broadest interpretation so as to encompass all such modifications.

What is claimed is:

1. A structure of temperature compensation for a liquid crystal display (LCD), the structure comprising:
an LCD panel;
a heat conductor disposed on the LCD panel;
a heat sensor, coupled to the heat conductor, for generating a signal according to the heat from the heat conductor; and
a computing unit, electrically coupled to the heat sensor, for generating a correction value according to the signal from the heat sensor, thereby correcting one or more voltages related to display performance.

2. The structure of claim 1, wherein the heat conductor is made of gold, silver, copper, aluminum, a heat pipe or combinations thereof.

3. The structure of claim 1, wherein the heat sensor comprises a thermistor.

4. The structure of claim 1, wherein the one or more voltages related to display performance comprises a Gamma voltage and a common voltage.

5. The structure of claim 1, wherein the heat conductor comprises a heat pipe.

6. A method for compensating one or more voltages of a liquid crystal display (LCD), the method comprising:
sensing temperature in a plurality of regions on an LCD panel;
generating a plurality of signals in accordance with the temperature sensed in the plurality of regions
generating a correction value of the one or more voltages for the LCD panel in accordance with the plurality of signals; and
adjusting the one or more voltages.

7. The method of claim 6, wherein the step of sensing temperatures in a plurality of regions on an LCD panel comprising conducting heat with a heat conductor made of gold, silver, copper, aluminum, a heat pipe or combinations thereof

8. The method of claim 6, wherein the one or more voltages are a Gamma voltage, a common voltage, or combinations thereof.
